(19) United States
(12) Patent Application Publication
(10) Pub. No.: US 2024/0184552 A1
(43) Pub. Date: Jun. 6, 2024

(54) COMPILERS AND COMPILING METHODS FIELD

(71) Applicant: XILINX, INC., San Jose, CA (US)

(72) Inventors: Steven Leslie POPE, Cambridge (GB); Dmitri KITARIEV, Newport Beach, CA (US); Neil Duncan TURTON, Cambridge (GB); Ripduman Singh SOHAN, San Jose, CA (US); Stephan DIESTELHORST, Cambridge (GB)

(21) Appl. No.: 18/073,219

(22) Filed: Dec. 1, 2022

(51) Int. Cl. G06F 8/41

(52) U.S. Cl. CPC G06F 8/4434; G06F 8/447

(57) ABSTRACT

A method comprises compiling, by a compiler, a received program to provide a compiler output for configuring hardware to implement the received program. The received program relate to packets of data in a memory. The compiling comprising defining by the compiler output a plurality of computational units in the hardware, each of the computational units being configured to receive a packet of data as a stream of words and between a first and a second of the computational units, a first buffer for storing words of a packet and a second buffer for storing data output by the first computational unit.

### TECHNICAL FIELD

This application relates to compilers and compiling methods and in particular but not exclusively to compilers and compiling methods for use with network interface devices.

### BACKGROUND

Network interface devices (e.g., a network interface card (NIC) or SmartNIC) are known and are typically used to provide an interface between a computing device and a network. Some network interface devices can be configured to process data which is received from the network and/or process data' which is to be put on the network.

For some network interface devices, there may be a drive to provide increased specializations of designs towards specific applications and/or the support of increasing data rates.

### SUMMARY

According to one aspect, there is provided a method comprising: compiling, by a compiler, a received program to provide a compiler output for configuring hardware to implement the received program, said received program relating to packets of data in a memory, said compiling comprising defining by the compiler output: a plurality of computational units in the hardware, each of the computational units being configured to receive a packet of data as a stream of words; and between a first and a second of the computational units, a first buffer for storing words of a packet and a second buffer for storing data output by the first computational unit.

The hardware which is configured may be provided in a network interface device.

The method may be performed in a network interface device.

The data output from the first computation unit may comprise data resulting from one or more actions performed by the first computation unit.

The data output from the first computation unit may comprise one or more of meta data, user data, and/or program data.

The compiling may comprise determining a plurality of accesses in the received program and converging two or more common accesses to provide a single converged access for two or more instructions, wherein the received program when run will execute one but not other of the two or more instructions.

The compiling may comprise defining a respective computation unit in the hardware to perform the respective single converged access.

The compiling may further comprise determining an order of the plurality of accesses and when converging two or more common accesses, maintaining the order of the plurality of accesses.

The compiling may further comprise inserting a first converge instruction before the single converged access and/or a second converge instruction after the single converged access.

The plurality of accesses may comprise map accesses.

The plurality of accesses may comprise packet accesses.

The compiling may further comprise adding packet modifying commands in a data stream, said packet modifying commands comprises one or more of adding data to and/or removing data from a packet.

The adding data to or removing data from the packet may comprise adding of a header to the packet or the removal of a header from the packet.

The compiling may further comprise providing a buffer between a first computational unit and a second computational unit which performs packet modification.

The compiling may further comprise providing tracking logic in one or more computational units to track the adding or removing of data from a packet.

The compiling may further comprise repacking logic in one or more computational units to repackage words of the packet to which the data has been added or removed.

The compiling may further comprise determining that two or more accesses to different memory locations are to be combined in a single access operation when the two or accesses are within a given range to a same set of memory locations.

The compiling may further comprise determining that two or more accesses to different memory locations are to be combined in a single access operation when the two or accesses associated with a common computed variable address are within a given range.

The compiling may further comprise determining that a single memory access is to two or more different sets of memory locations and splitting the single memory access into a plurality of different memory accesses each to a respective set of memory locations.

The compiling may further comprise determining that a memory access is associated with a computed variable address which is potentially, depending on a value of the computed variable address, associated with two or more different sets of memory locations and providing a plurality of different memory accesses each to a respective set of memory locations.

The compiling may further comprise determining a number of program branches in the received program and reducing the number of program branches by causing one or more instructions associated with the program branches to be implemented conditionally.

The compiling may further comprise determining a number of program branches in the received program and reducing the number of program branches following one another by combining two or more branches into a switch.

The compiling may comprising compiling the received program to an intermediate representation and compiling the intermediate representation to provide the output.

The intermediate representation may comprise an LLVM intermediate representation.

The received program may be an EBPF program.

The output may be an output program.

The output program may comprise a C or C++ program.

The hardware may comprise programmable logic.

The hardware may comprise a plurality of processing units.

According to another aspect, there is provided an apparatus comprising: a compiler, the compiler being configured to compile a received program to provide a compiler output for configuring hardware to implement the received program, said received program regarding a packet of data in a memory, said compiling comprising defining in the compiler output: a plurality of computational units in the hardware, each of the computational units being configured to receive a packet of data as a stream of words; and between a first and a second of the computational units, a first buffer for storing words of a packet and a second buffer for storing data output by the first computational unit.

The hardware which is configured may be provided in a network interface device.

The apparatus may be provided in a host device or in a network interface device.

The compiler may be provided by a processor and a memory storing computer instructions that when executed provide the compiling.

The data output from the first computation unit may comprise data resulting from one or more actions performed by the first computation unit.

The data output from the first computation unit may comprise one or more of meta data, user data, and/or program data.

The compiler may be configured to determine a plurality of accesses in the received program and converging two or more common accesses to provide a single access for two or more instructions, wherein the program when run will execute one but not other of the two or more instructions.

The compiler may be configured to define a respective computation unit in the hardware to perform a respective single access.

The compiler may be configured to determine an order of the plurality of accesses and when converging two or more common accesses, maintaining the ordering of the plurality of accesses.

The compiler may be configured to insert a first converge instruction before a single converged access and/or a second converge instruction after the single converged access.

The plurality of accesses may comprise map accesses.

The plurality of accesses may comprise packet accesses.

The compiler may be configured to add packet modifying commands in a data stream, said packet modifying commands comprises one or of adding data to or removing data from a packet.

The adding data to or removing data from the packet may comprise adding of a header to the packet or the removal of a header from the packet.

The compiler may be configured to provide a buffer between a first computational unit and a second computational unit which performs packet modification.

The compiler may be configured to provide tracking logic in one or more computational units to track the adding or removing of data from a packet.

The compiler may be configured to provide repacking logic in one or more computational units to repackage words of the packet to which the data has been added or removed.

The compiler may be configured to determine that two or more accesses to different memory locations are to be combined in a single access operation when the two or accesses are within a given range to a same set of memory locations.

The compiler may be configured to determine that two or more accesses to different memory locations are to be combined in a single access operation when the two or accesses associated with a common computed variable address are within a given range.

The compiler may be configured to determine that a single memory access is to two or more different sets of memory locations and splitting the single memory access into a plurality of different memory accesses each to a respective set of memory locations.

The compiler may be configured to determine that a memory access is associated with a computed variable address which is potentially, depending on a value of the computed variable address, associated with two or more different sets of memory locations and providing a plurality of different memory accesses each to a respective set of memory locations.

The compiler may be configured to determine a number of program branches in the received program and reducing the number of program branches by causing one or more instructions associated with the program branches to be implemented conditionally.

The compiler may be configured to determine a number of program branches in the received program and reducing the number of program branches following one another by combining two or more branches into a switch.

The compiler may be configured to compile the received program to an intermediate representation and compile the intermediate representation to provide the output.

The intermediate representation may comprise an LLVM intermediate representation.

The received program may be an EBPF program.

The output may be an output program.

The output program may comprise a C or C++ program.

The hardware may comprise programmable logic.

The hardware may comprise a plurality of processing units.

According to a further aspect, there is provided a computer program comprising instructions, which when executed by an apparatus, cause the apparatus to perform any of the methods set out previously.

According to a further aspect, there is provided a computer program comprising instructions, which when executed cause any of the methods set out previously to be performed.

According to an aspect there is provided a computer program comprising computer executable code which when executed cause any of the methods set out previously to be performed.

According to an aspect, there is provided a computer readable medium comprising program instructions stored thereon for performing at least one of the above methods.

According to an aspect, there is provided a non-transitory computer readable medium comprising program instructions which when executed by an apparatus, cause the apparatus to perform any of the methods set out previously.

According to an aspect, there is provided a non-transitory computer readable medium comprising program instructions which when executed cause any of the methods set out previously to be performed.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF FIGURES

Some embodiments are illustrated by way of example only in the accompanying drawings. The drawings, however, should not be construed to be limiting of the arrangements to only the particular implementations shown. Various aspects and advantages will become apparent upon review of the following detailed description and upon reference to the drawings.

FIG. 1 shows a schematic view of a data processing system coupled to a network.

FIG. 2 shows a network interface device of some embodiments.

FIG. 3 shows an overview of a compiler structure of some embodiments.

FIG. 4 shows a first example of computational units provided in programmable logic, in some embodiments.

FIG. 5 shows an example of the order that words are received by computational units provided in programmable logic.

FIG. 6 shows a second example of computational units provided in programmable logic, in some embodiments.

FIG. 7 schematically shows part of a first EBPF program on the left and the converging of map access associated with that program on the right.

FIG. 8 schematically shows part of a second EBPF program on the left and the converging of map access associated with that program on the right.

FIG. 9a shows a third example of computational units provided in programmable logic, in some embodiments.

FIG. 9b schematically shows two examples where data is deleted from a packet.

FIG. 9c schematically shows an example where data is added to a packet.

FIG. 10 schematically shows a compiling stage of some embodiments.

FIG. 11 schematically represents a computational unit without any tap information.

FIG. 12 schematically represents the computational unit of FIG. 11 with tap information.

FIG. 13 schematically represents the computational unit of FIG. 12 with tap optimization.

FIG. 14 illustrates schematically another network interface device according to some embodiments.

FIGS. 15a to 15e schematically illustrate the combining of accesses with known offsets and with computed offsets provided by the compiler of some embodiments.

FIGS. 16a and 16b schematically illustrate the splitting of accesses with known offsets and with computed offsets provided by the compiler of some embodiments.

FIGS. 17a and 17b schematically illustrate the reduction of program branching provided by the compiler of some embodiments; and

FIG. 18 shows a method of some embodiments.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

When data is to be transferred between two data processing systems over a data channel, each of the data processing systems has a suitable network interface to allow it to communicate across the channel. The data channel may be provided by a network. For example, the network may be based on Ethernet technology or any other suitable technology. The data processing systems may be provided with network interfaces that are capable of supporting the physical and logical requirements of the network protocol. The physical hardware component of network interfaces are referred to as network interface devices or network interface cards (NICs). In this document, the network interface device is referred to a NIC. It should be appreciated that the NIC may be provided in any suitable hardware form such as an integrated circuit or a hardware module. A NIC is not necessarily implemented in card form and is more commonly implemented at least partially by one or more integrated circuits and/or one or more dies and/or one or more chiplets. Alternatively, the network interface device may be part of a larger integrated circuit. The network interface device 109 may be provided by a single hardware module or by two or more hardware modules.

The network interface device may provide a network attached CPU in front of the main CPU. The network interface device will be located on a data path between the host CPU and the network.

Computer systems may have an operating system (OS) through which user level applications communicate with the network. A portion of the operating system, known as the kernel, includes protocol stacks for translating commands and data between the applications and a device driver specific to the network interface device. By providing these functions in the operating system kernel, the complexities of and differences among network interface devices can be hidden from the user level applications. The network hardware and other system resources (such as memory) may be safely shared by many applications and the system may be secured against faulty or malicious applications.

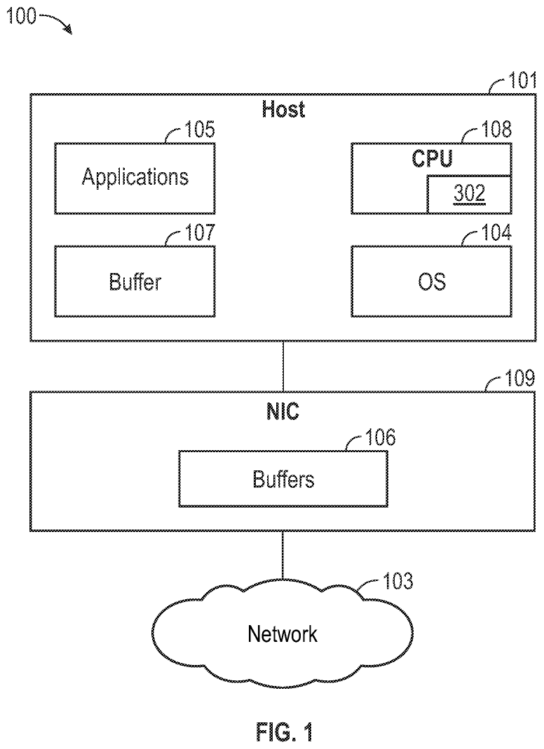

A typical data processing system 100 which puts data onto a network for transmission and receives data from the network is shown in FIG. 1. The host computing device 101 may comprise one or more processors and one or more memories.

In the example schematically shown in FIG. 1, the data processing system 100 comprises a host computing device 101 coupled to a network interface device 109 that is arranged to interface the host to network 103. The host computing device 101 includes an operating system 104 supporting one or more user level applications 105. The host computing device 101 may also include a network protocol stack (not shown). The network protocol stack may be a Transmission Control Protocol (TCP) stack or any other suitable protocol stack. The protocol stack may be a transport protocol stack.

The host may comprise one or more CPUs 108 or processors. These one or more CPUs 108 may provide the OS 104 and/or one or more of the applications 105 or may be in addition to the one or more processors providing the OS and/or the applications 105.

An application 105 may send and receive TCP/IP (Internet Protocol) messages by opening a socket and reading and writing data to and from the socket, and the operating system 104 causes the messages to be transported across the network.

Some systems may offload at least partially the protocol stack to the network interface device 109. For example, in the case that the stack is a TCP stack, the network interface device 109 may comprise a TCP Offload Engine (TOE) for performing the TCP protocol processing. By performing the protocol processing in the network interface device 109 instead of in the host computing device 101, the demand on the host computing device's 101 processor/s may be reduced. For example, data to be transmitted over the network, may be sent by an application 105 via a TOE-enabled virtual interface driver, by-passing the kernel TCP/IP stack entirely. Data sent along this fast path therefore may need only be formatted to meet the requirements of the TOE driver.

In some embodiments, the host computing device 101 and the network interface device 109 may communicate via a bus, for example a peripheral component interconnect express (PCIe bus) or any other suitable bus.

During operation of the data processing system, data to be transmitted onto the network may be transferred from the host computing device 101 to the network interface device 109 for transmission. In one example, data packets may be transferred from the host computing device to the network interface device directly by the host processor. The host may provide data to one or more buffers 106 located on the network interface device 109. The network interface device 109 may then prepare the data packets and transmit them over the network 103.

Alternatively, the data may be written to a buffer 107 in the host computing device 101. The data may then be retrieved from the buffer 107 by the network interface device and transmitted over the network 103. Some systems may support both of these data transfer mechanisms.

In both of these cases, data may be temporarily stored in one or more buffers prior to transmission over the network.

The data processing system may also receive data from the network 103 via the network interface device 109.

A data processing system could be any kind of computing device, such as a server, personal computer, or handheld device.

Some embodiments may be suitable for use in networks that operate TCP/IP over Ethernet. In other embodiments one or more different protocols may be used.

Embodiments may be used with any suitable networks, wired or wireless.

The NIC may be configurable to provide application specific pipelines to optimise data movement and processing. The NIC may integrate high-level programming abstractions for network and compute acceleration

Some embodiments may be used to support a relatively high date rate. For example, the NIC of some embodiments support terabit class endpoint devices. Some embodiments may be able to support terabit data rate processing. For example the NIC may receive data from the network at a terabit data rate and/or put data onto the network at a terabit data rate. However, it should be appreciated that other embodiments, may operate at and/or support lower data rates.

When data packets are sent and received from over a network 103, there are many processing tasks that can be expressed as operations on a data packet either on a data packet to be transmitted over the network or on a data packet received from over the network. For example, filtering processes may be carried out on received data packets so as to protect the host computing device 101 from distributed denial of service (DDOS) filtering.

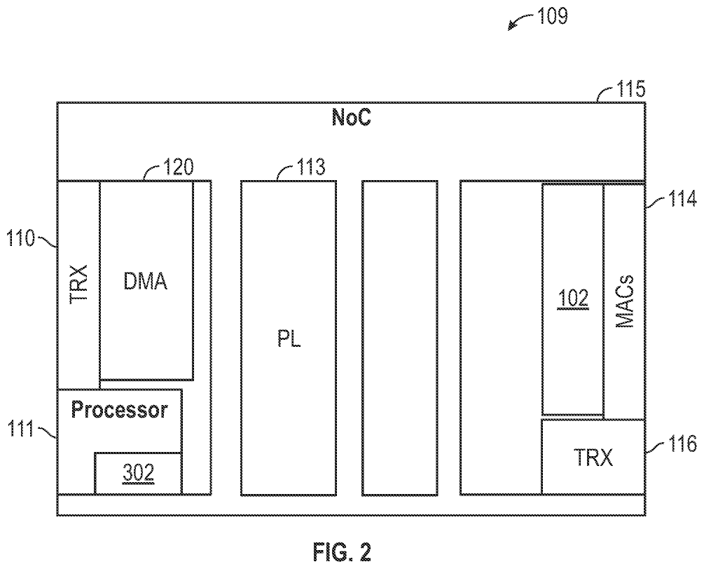

Reference is made to FIG. 2 which shows an example network interface device 109 of some embodiments.

The arrangement of FIG. 2 may be regarded as providing a System-on-Chip (SoC). The SoC shown in FIG. 2 is an example of a programmable integrated circuit IC and an integrated programmable device platform. In the example of FIG. 2, the various, different subsystems or regions of the network interface device 109 may be implemented on a single die provided within a single integrated package. In other examples, the different subsystems may be implemented on a plurality of interconnected dies provided as a single, integrated package. In some embodiments, the network interface device 109 of FIG. 2 may be provided by two or more packages, one or more integrated circuits and/or by one or more chiplets.

In the example of FIG. 2, the network interface device 109 includes a plurality of regions having circuitry with different functionalities.

In the example, the network interface device 109 has a processing system provided by one or more processors 111. The one or more processors 111 may be provided by one or more CPUs or processing cores. The one or more processing may be placed in any suitable location or locations on the network interface device 109.

The network interface device 109 has one or more first transceivers 116 for receiving data from a network and/or for putting data onto a network. The network interface device 109 has one or more virtual switches (vSwitch) or protocol engines 102. One example of a protocol engine is a transport protocol engine. The network interface device 109 has one or more MAC (medium access control) layer functions 114. The network interface device 109 has one or more second transceivers 110 for receiving data from the host computing device 101 and/or for providing data to the host computing device 101.

The network interface device 109 has a DMA (direct memory access) architecture 120. In one embodiment, the various elements in the architecture 120 are formed from hardware in the network interface device 109, and thus are circuitry. This DMA architecture 120 may comprise a PCIe (peripheral component interconnect express) interface and one or more DMA (direct memory access) adaptors. The one or more DMA adaptors may provide a bridge between the memory domain and packet streaming domain. This may support memory-to-memory transfers.

The network interface device 109 has a network on chip (NoC) 115 which is shaded in FIG. 2. This may provide communications paths between different parts of the network interface device 109. It should be appreciated that two or more of the components on the network interface device 109 may alternatively or additionally communicate via direct connection paths and/or dedicated hardened bus interfaces.

The area between the NoC may include one or more components. For example, the area may accommodate one or more programmable logic (PL) blocks 113 or programmable circuitry. This area is sometimes referred to as the fabric. By way of example only, the PL blocks may at least partially be provided by one or more FPGAS (field programmable gate array). The area may accommodate one or more look up tables LUTs. One or more functions may be provided by the PL blocks. The ability to accommodate different functions in this area may allow the same NIC to be used to satisfy a variety of different end user requirements.

It should be appreciated that in other embodiments, any other suitable communication arrangement may be used on the NIC instead of or in addition to the NoC.

The NIC provides an interface between a host device and a network. The NIC allows data to be received from the network. That data may be provided to the host device. In some embodiments, the NIC may process the data before the data is provided to the host device. In some embodiments, the NIC allows data to be transmitted by the network. That data may be provided from the host computing device and/or from the NIC. In some embodiments, the NIC may process the data before the data is transmitted by the network.

The virtual switch or protocol engine 102 is able to communicate with other blocks on the chip using the NoC and/or via direct connection paths and/or dedicated hardened bus interfaces. In some embodiments, this may be dependent on the capacity of the NoC versus the quantity of data to be transported.

The NoC may for example be used for memory access by the network interface device 109. The NoC 115 may be used for delivering data to the at least one processor 111, the DMA adaptors and/or the PCIe blocks.

In some embodiments, the NoC and/or direct connection paths and/or dedicated hardened bus interfaces may be used to deliver data to one or more accelerator kernels and/or the like. In some embodiments, routing may be via the PL. The accelerator kernels are sometimes referred to as plugins. These plugins may in some embodiments be provided by the PL blocks 113 or any suitable programmable circuitry.

Some embodiments may allow a customized NIC function to be provided. This may be useful where a specific NIC function is required. This may be for a particular application or applications or a for a particular use of the NIC. This may be useful where there may be a relatively low volume of devices which are required to support that NIC function. Alternatively or additionally this may be useful where customization of a NIC is desired. Some embodiments, may provide a flexible NIC.

The customization may be supported by providing one or more functions using the PL blocks 113 or programmable circuitry. The customization may alternatively or additionally be supported by code which runs on the at least one processor 111 of the NIC.

Some embodiments may use EBPF (extend Berkley packet filter) or similar instruction set architecture or language such as P4 or the like. C may be used to write programs for EBPF.

EBPF is a relatively simple instruction set architecture. The EBPF language can be executed efficiently on an x86/Arm or any other suitable processor. JIT (just in time) compilation techniques enable EBPF programs to be compiled to native machine code. EBPF is relatively easy to translate to x86/Arm or the like processing. EBPF has simple encodings and is RISC (reduced instruction set computer)-like. EPBF supports integer maths, bit manipulations, conditionals, jumps and load/ store operations. It only has bounded loop, pointer and type checking.

Some embodiments use EBPF in the implementation of custom programs (or accelerators) on the NIC.

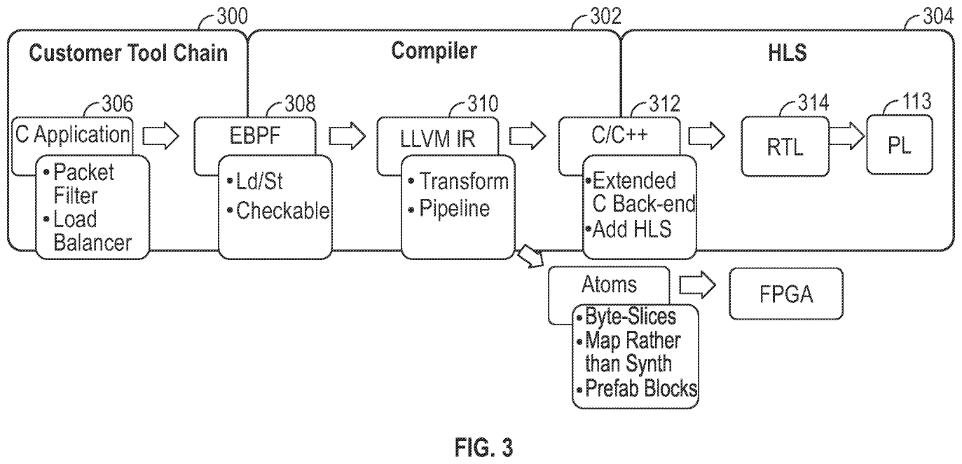

Reference is made to FIG. 3 which shows an overview of a compiler structure of some embodiments. This structure has a customer tool chain part 300, a compiler part 302 and a high level synthesis (HLS) part 304. Some embodiments provide a data-flow compiler built within a LLVM framework.

Some embodiments may be used, for example, to provide a generally deployable offload feature for data-centre networked devices or any other suitable devices.

In the customer tool chain 300, in one embodiment, a program 306 is written in C and compiled to EBPF 308. Depending on the situation, the customer tool chain may be provided by the data processing system 100 (e.g., the customer tool chain 300 may be executed by the OS 104 and the CPU 108) or may be provided by separate computing components. In some embodiments, the data processing system 100 may be used to write the C program 306 and may do the compiling to provide the EBPF program 308. In some embodiments, the data processing system 100 may receive the program 306 from an external source and may do the compiling to provide the EBPF program 308. In other embodiments, the data computing system may receive the EBF program 306 from an external source

In the compiler 302 shown in FIG. 3, the programs written in EBPF are compiled. The resulting compiled programs will run partially on the NIC or just on the NIC. In some embodiments, the resulting programs will run on the PL of the NIC and/or other hardware components of the NIC. The computational units or operation stages may be provided on the NIC, for example by the PL.

The compiler 302 may be provided by the NIC and/or by the host. The compiler flow may be run on any general purpose CPU or processor provided by the NIC and/or the host computing device 101. For example, where the compiler is provided on the NIC, the compiler may be provided at least partially by the at least one processor 111 (as schematically shown in FIG. 2). For example, where the compiler is provided on the host, the compiler may be provided at least partially by the CPU 108 and/or another processor (as schematically shown in FIG. 1).

The compiler 302 has a front end in which EBPF binary is compiled to a LLVM Intermediate Representation (IR) 310.

In some embodiments, for the back end of the compiler, C or C++ or a similar language code is generated, as referenced 312. Support of HLS annotations is provided. The code 312 can be fed into, for example, the HLS part 304. The HLS part 304 is provided by the NIC and/or by the host computing device. The HLS part 304 may be provided in part by at least one processor. For example, the HLS may be provided at least in part by CPU 108 or processor 111. In the HLS part 304, the code is transformed to an RTL model 314.

The compiler may be provided by a processor and a memory storing computer instructions that when executed provide the compiling.

In some embodiments, the back end of the compiler 302 may generate an RTL model directly without using the intermediate HLS step

Although not shown, synthesis converts the RTL model into a form (e.g. a bit file), suitable for PL blocks 113 and/or other hardware and/or circuitry of the NIC. The PL blocks 113 and/or other hardware and/or circuitry of the NIC is configured with the bit file. This allows, for example, the PL blocks 113 to provide the required functionality. Thus in the example, design files to be synthesised into the PL blocks 113, in the example NIC of FIG. 2, are written.

In other embodiments, the LLVM IR 310 stage of the compiler is used to provide atom configuration. In one embodiment, atoms are byte-sized “mega cells” with flexible operations and flexible connections. In some scenarios, it may be quicker to configure the atoms instead of using HLS. Thus, in this example, atoms are provided in the PL blocks 113, in the example NIC of FIG. 2 which can be configured responsive to the output of the LLVM IR 310.

In other embodiments, the back end of the compiler 302 generates code which will run on the processor 111 in the example network interface device 109 of FIG. 2. This may be the code referenced 312.

Some examples of transformations of the EBPF program provided by the compiler will now be described.

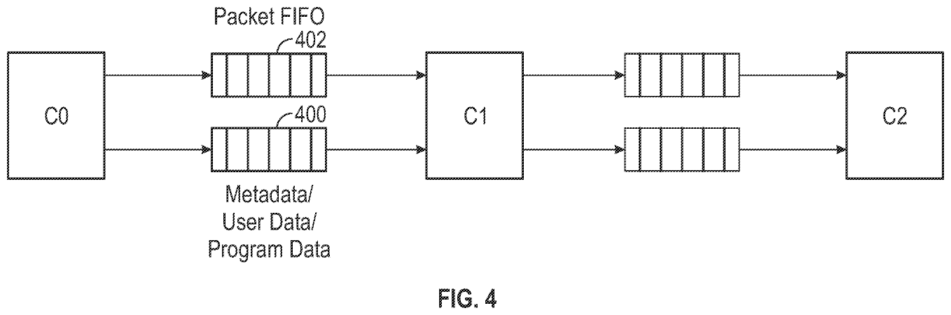

FIG. 4 shows the basic structure provided by the compiler to address the challenge that EBPF regards a packet as a flat array but the hardware (e.g. the PL) sees packet words streaming through it. A packet is make up of a number of words. A challenge arises where the hardware needs a later word in order to process a current word.

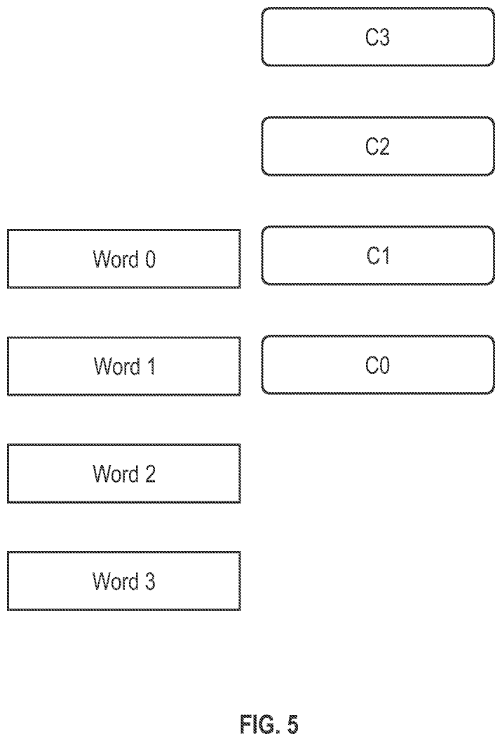

In the example shown in FIG. 4, there are a plurality of computational units C0, C1 and C2. In practice, there may be more three computational units. These computational units are provided in the PL blocks 113, in some embodiments. Each stage receives a word of a packet at a time. The words are received in the order shown in FIG. 5, that is word 0, word 1, word 2 and word 3. The computational units C0 to C3 may require the words in a different order.

In the following example, assume the computational unit C0 has to wait for word 3 in order to compute its result. The computational unit C0 will output the result of its computation to the computational unit C1 via FIFO 400. This can be metadata, user data and/or program data. In addition words 0, 1 and 2 (which were received prior to word 3) are in a FIFO 402 which is output to the computational unit C1. This means that the computational unit C1 will have the word or words that it needs in order to compute the next result. For example the computational unit C1 may require the output of the computational unit C0 and word 0 to compute its output. The result computed by the computational unit C0 will bypass the FIFO 402 by using the FIFO 400 so that the result is received before or with the word which is needed by C1 to compute the next result.

The compiler will thus determine for each computational unit required by the EBPF program, what words or data are required by that computational unit and provide the buffering or FIFO stages, such as illustrated in FIG. 4 to ensure that each computational unit has the required words or data to perform its computation.

In other embodiments, the compiler may as a default provide a packet FIFO or buffer 402 for the received words and a buffer or FIFO 400 for the metadata, user data and/or program data from the preceding computational unit.

In the example shown in FIG. 4, there is no buffering provided prior to the first computational unit. It should be appreciated that in some embodiments, there may be buffering prior to the first computational unit C0.

In some embodiments, the compiler may convert map lookup calls and memory accesses to memories/CAMs. When on the host device, the assumption is that, memory accesses are “cheap” and can be easily accommodated as required. However, this may not be the case on a NIC.

Maps are containers that store key-value pair elements in sorted form. The values can be accessed from the map through the keys themselves. In other words, the keys identify the elements whose content is the mapped value.

A map access can be used to access different types of maps (e.g. a lookup table), including direct indexed array and associative array. A map access may comprise at least one of: reading a value from a location; writing a value to a location; and/or replacing a value at a location in the map with a different value.

A map access may comprise a compare operation in which a value is read from a location in the map and compared with a different value. If the value read from the location is less than the different value, then a first action (e.g. do nothing, exchange the value at the location for the different value, or add the values together) may be performed. Otherwise, a second action (e.g. do nothing, exchange or add a value) may be performed. In either case, the value read from the location may be provided to the next processing stage.

The compiler may determine map accesses in the EBPF program. For example, this may be load/store operation to the memory returned by the map lookup (key)—(e.g. Id/st to memory returned by map_lookup(key)). These map accesses may be converted to map read/write operations on CAMs. (e.g. map_read_byte(key, offs)/map_write_byte(key, offs, data))

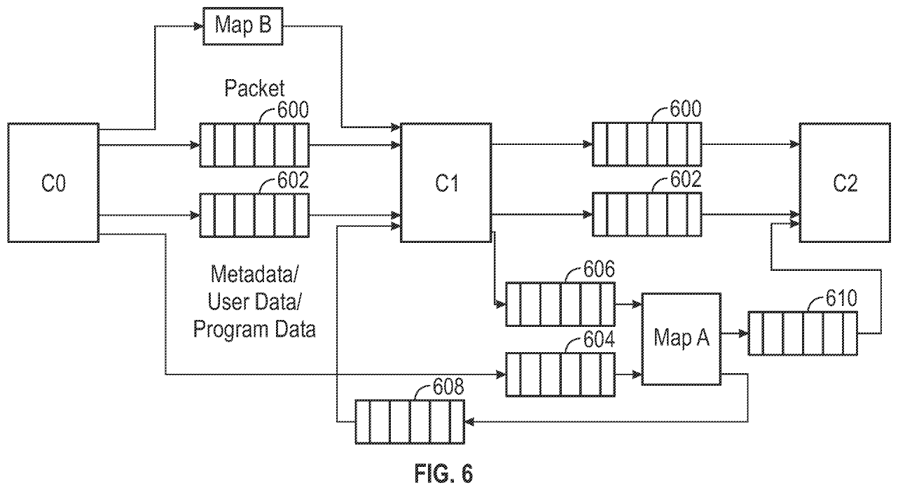

FIG. 6 shows an example where the computational unit C0 performs a first map access, MAP B, and an output is provided to the computational unit C1 which will use that output. In general, a different stage will receive the response to the stage making the request. In this example, stage C0 is making the request and stage C1 is receiving the response.

FIG. 6 also shows a more complicated map access, MAP A. In this scenario, there is a map access from the computational unit C0 and the computational unit C1 via respective FIFOs 604 and 606 and an output to both the computational units C1 and C2 via respective FIFOs 608 and 610. FIFOs 604 to 610 can buffer the inputs/outputs to make sure that the right data is available as required. In this example stage C0 sends a request to map A and the response to that request is sent to stage C1. Stage C1 also can send a request to map A and a response to that request is sent to stage C2.

As shown in this example, a single map (e.g., map A) can be accessed in two or more places in the pipeline and the response will be provided to the next (or a later) stage.

Between the computational unit C0 and the computational unit C1 is a packet FIFO 600 for the words and a FIFO 602 for the metadata, user data and/or program data. Between the computational unit C1 and the computational unit C2 is a packet FIFO 600 for the words and a FIFO 602 for the metadata, user data and/or program data.

The maps are implemented as CAMs and RAMs. The packet/map access taps (i.e., a structure which connects the map to the pipeline) are considered to be “expensive”. Accordingly, in embodiments, the packet/map access taps are shared where possible. The compiler performs a converge pass to converge the control flow of the program whenever an access tap is used so that different paths through the program can access the same tap. The rearrangements performed by the converge pass preserve the order of the map/packet accesses. The map is where data is stored and the map access tap is a structure which connects the map to the pipeline.

A packet access can comprise at least one of: reading a sequence of bytes from the data packet; replacing one sequence of bytes with a different sequence of bytes in the data packet; inserting bytes into a data packet; and deleting bytes in the data packet. The compiler is configured to discover packet accesses in the program and provide packet access taps for the packet accesses—that is to the location where the packet is stored.

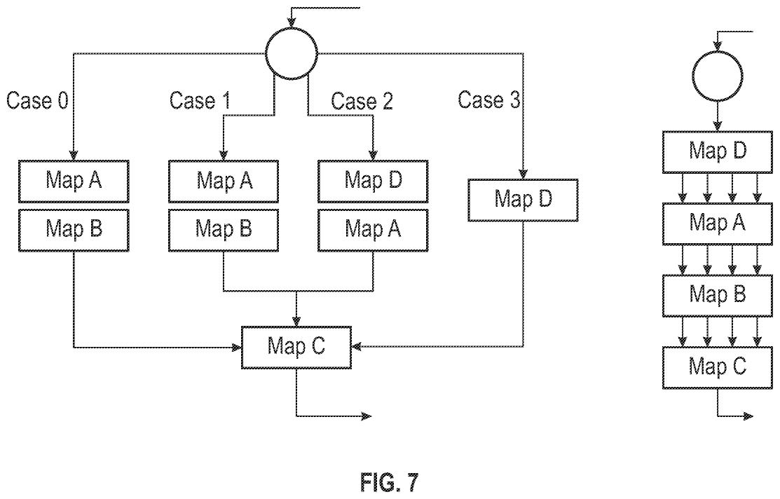

FIG. 7 schematically shows a EBPF program on the left where there are four cases.

The program may be as follows

```
      switch( packet[15] ) {
  case 0:
    map_lookup(map_A,..);
    map_lookup(map_B,..); break;
  case 1:
    map_lookup(map_A,..);
    map_lookup(map_B,..); break;
  case 2:
    map_lookup(map_D,..);
    map_lookup(map_A,..); break;
  case 3:
    map_lookup(map_D,..);
}
map_lookup(map_C,..);
```

For case 0, there is a map lookup of map A followed by a map look up of map B. For case 1 there is a map lookup of map A followed by a map look up of map B. For case 2, there is a map lookup of map D followed by a map look up of map A. For case 3, is a map lookup of map D. All cases are followed by a map look up of map C.

As a result of the compiling the program, the map accesses are converged as shown on the right of FIG. 7. As can be seen the ordering of the map accesses is maintained. Access to Map D is the first map access as it is never the second map access. This is followed by access to Map A as this is always done before access to Map B. This followed by Map B and finally Map C. A particular access will be associated with a given pipeline stage. The map itself, however, may be accessed by two or more stages.

It should be appreciated that in some embodiments, the compiler comprises determining a plurality of accesses in the program and converging two or more common accesses to provide a single access for two or more instructions. It should be noted that these instructions may “live on” different paths through the program, i.e., there is never a path of through the program that may execute both operations'

One aim of the converge pass provided by the compiler is to try and create an order where every map is only accessed once (see the example on the right part of FIG. 7), because having only a single map access may make further optimisations possible.

When that is not possible (for example, if the access to map C in left part of FIG. 7 were instead to map A), the compiler would try and minimise the number of accesses, but would have a single map that would have to be accessed by two or stages with the associated circuitry cost (e.g. FIFOs, bus logic and/or the like.)

The above program after converging may be:

```
    if( path == 2 ∥ path == 3)
  op = LOOKUP;
else
  op = NOOP;
map_lookup(map_D, op, ..);
switch( path ) {..}
..
if( path == ..) {..} else {..}
map_lookup(map_A);
..
map_lookup(map_B);
..
map_lookup(map_C);
```

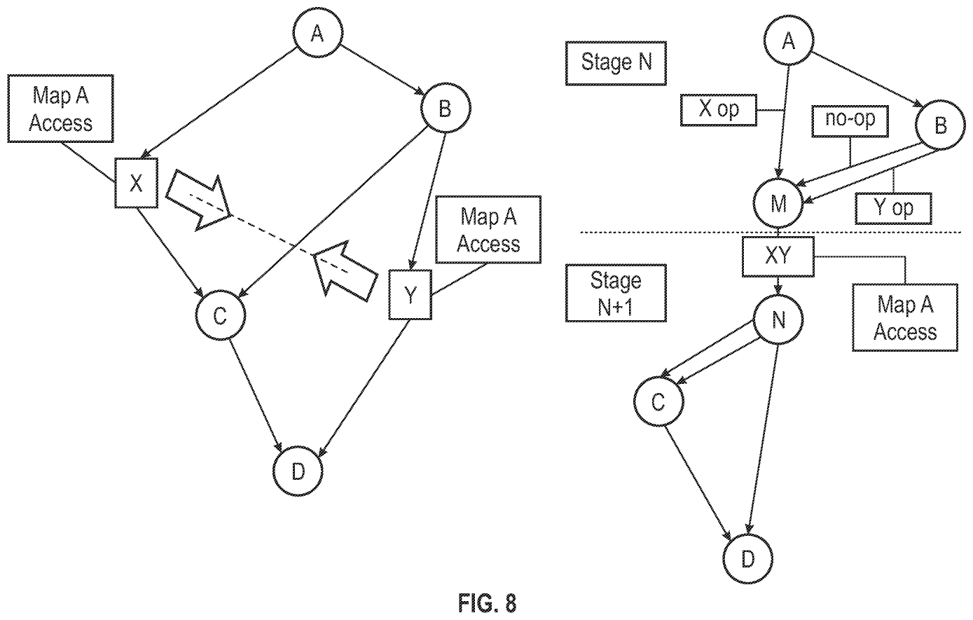

FIG. 8 shows a simpler example. Instruction A is followed by instruction X (which is access to Map A) or by instruction B. Instruction X is followed by instruction C. Instruction B is followed instruction Y (which is access to Map A) or by instruction C. Instruction Y and instruction C are followed by instruction D. This is shown on the left. The right shows the converged pass where computation stage N+1 will carry out the map A access for X and Y.

An example program associated with the example shown in FIG. 8 may be as follows.

| | A: n = packet[14]; |
|---|---|
| if( n == 42 ) { | |
| X: | map_lookup( map_A, ..); |
| B: | } else if ( n == 17 ) { |
| Y: | map_lookup( map_A, ..); |
| | goto D; |
| } | |
| C: | packet[29] = 127; |
| D: | return XDP_PASS; |

In more detail, the compiler will provide a first computation stage N which will perform instruction A. This will generate an operand X which may be used by the instruction X. As instruction X is provided in a next computational unit N+1, this operand X will be output to the next computational unit N+1 via an intermediate instruction M of the computational unit.

The instruction A may provide an output which is used by instruction B to provide an operand Y which is used by instruction Y. As instruction Y is provided in the next computational unit N+1, this operand Y will be output to the next computational unit N+1 via the intermediate instruction M of the computational unit N.

The instruction B may provide a further output no-op which is used by instruction C. As instruction C is provided in the next computational unit N+1, this output will be output to the next computational unit N+1 via the intermediate instruction M of the computational unit N.

Instruction M is provided to ensure that the Y operand, the X operand and the further output no-op, as required, are associated to the correct instruction in the next stage.

In the next stage the map access to map A is performed. This will be for map access X and/or Y (which are the same map—map a) using the respective operand.

This is followed instruction N. Instruction N is provided to ensure that the correct output is provided to instruction C and to instruction D. Instruction N will provide the result of map access X or the further output no-op to instruction C and the result of map access Y to instruction C. Instruction C will also provide an output to instruction D.

It will be appreciated that the instructions which are required to be performed may be conditional as exemplified by the example program.

As mentioned, currently access to a single map/CAM from any number of pipeline stages through a bus and FIFO structure is supported. Having a map as a per-stage CAM (without any externally visible logic outside the stage) is an optimisation provided by the compiler in some embodiments.

The converge pass provided by the compiler of some embodiments may do one or more of the following:

Lift accesses to the packet and maps to the top-level of the execution (there are no program paths not doing a packet/map access), paths that would not have done a packet/map access perform a no-op packet/map operation. Additional care has to be taken to preserve the application control flow (This is illustrated in the example of FIG. 8 where instructions M and N are used to preserve the application flow)

Try and combine accesses on different paths of the program together in order to reduce the number of packet/map access taps that are needed, and potentially enable the per-stage CAM optimisation mentioned previous (this is illustrated in the examples shown in FIGS. 7 and 8)

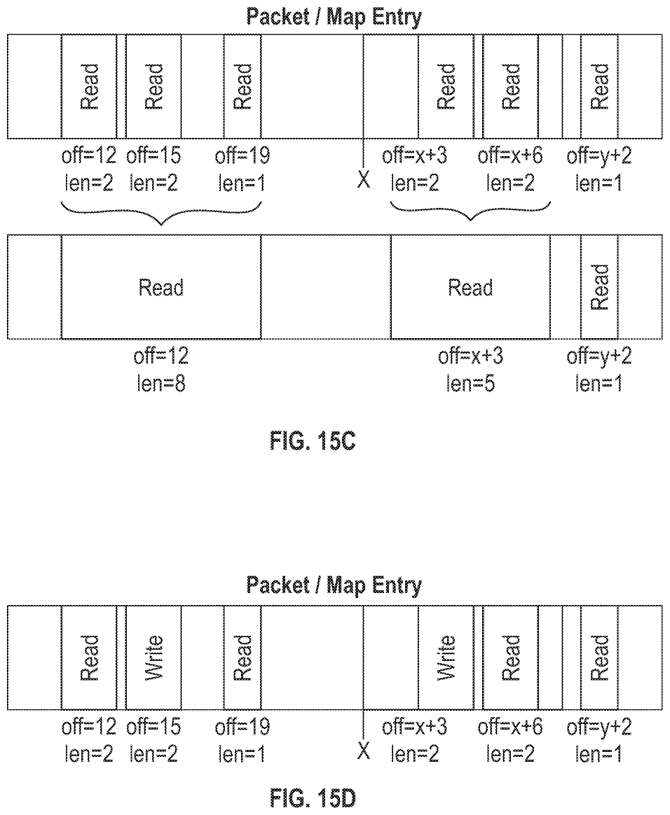

Reference is made to FIGS. 15a to 15e which shows some examples of the merging of packet/map accesses performed by the compiler even in the case where the base address is unknown.

The compiler of some embodiments may merge packet and/or map accesses, where possible, to have fewer accesses in the program. This may save on the amount of area required in the hardware such as the PL to provide the compiled program as the number of taps may be reduced and/or there may be fewer pipeline stages. However, the address of all the accesses may not be known.

Consider the following example shown in FIG. 15a where the accesses are in the form of reads. In the example there are three reads. The first read has an offset of 12 and a length 2. The second read has an offset of 15 and a length of 2 and the third read has an offset of 19 and a length 1. The offset is defined with respect to a known base address and defines the memory location in which the data is to be read. The length defines the number of memory locations to be accessed. In this example, the addresses of the three memory locations of the three read operations are known. As can be seen from FIG. 15a, these three read operations can be merged by the compiler into a single read operation starting at the offset 12 and having a length 8. This will provide all of the data required by the three separate operations.

However, in some situations the accesses may have a computed variable address such as illustrated in FIG. 15b. In this example, there are a further three read operations. The fourth read operation has an offset of a and a length of 2, the fifth read operation has an offset of b and a length of 2 and the sixth read operation has an offset of c and a length of 1. In this example, a, b, and c represent the computed variable address.

In some embodiments, read accesses which are within a given address range may be merged. For example, if the read access are within an address range within a length of n may be merged. The value of n be determined based on the hardware. By way of example n may be 8 or 32 or any other suitable number. In some embodiments, a read access may be merged where the read access are within a given range and to a same memory bank. The term memory bank as used in this application refers to a set of memory locations which are capable of being accessed in a single memory access.

As the compiler does not know where the accesses are, they cannot simply be merged as discussed in relation to the example of FIG. 15a. The accesses may be widely distributed or close together.

In some embodiments, the computation for a, b, c is inspected symbolically by the compiler and the compiler groups together accesses which are associated with a common base.

Consider the following example illustrated in FIG. 15c:

a=x+3

b=x+6

C=y+2

As can be seen, addresses a and b have a common base of x, so can be merged. As address c is associated with a different base, y, that access cannot be merged with those associated with the common base of x. Thus in the example of FIG. 15c, the fourth and fifth reads are merged with an offset of x+3 and a length of 5. The sixth read is not merged and is performed as a separate access.

There may be more complex computations of the address. Consider the following example:

a=(x+28)/8

b=(x+48)/8

This requires symbolic tracking of complex computations and the remainders from the division. The compiler may analyse the expressions and represent them as computation trees. The compiler may want to know the remainder of the division by eight. For that, the compiler analyses the addition operation and sees that in order to know the remainder, the compiler needs to know the lower bits/remainder of x in the expressions. If those are known, together with the constants, the compiler may be able to prove that (x+28)/8 divides cleanly (remainder zero) or always has a constant remainder (say 4). That allows the compiler to notice that a and b will be at a constant distance from one another, and therefore can be merged.

For that, the compiler goes backwards through the computation of a and b and attempts to infer that information.

The compiler may make sure that the ordering of accesses is taken into account when merging accesses. In particular, the compiler may ensure that the ordering of reads and writes are maintained. In other words, if the program defines a read to a location followed by a write to the same location, the compiler will ensure that this order is maintained.

Consider the following example program which is schematically shown in FIG. 15d:

read(12,2)

write(15,2)

write(x+3,2)

read(19,1)

read(x+6,2)

read(y+2, 1)

In this example, the merging of read(12,2), write(15,2), write(x+3,2) and read (19, 1) should be avoided as the unknown value of x+3 means that the write (x+3, 2) could overlap with the read (19,1). This is illustrated in the example of FIG. 15e, where x lies between offset 15 and 19.

However, read(12,2) and write(15,2) can be merged as there is no unknown write in between.

By shuffling read (19,1) with read (x+6, 2) this means that write(x+3, 2) and read(x+6,2) can be merged. It should be appreciated that shuffling the order of the reads does not cause any issue here as both read operations are after the write operation.

The compiler may modify the above program as follows:

read(12,2) and write(15,2) are merged into a single access (12,5) where reading and writing are carried out at the same time but with respect to the different memory locations;

write (x+3, 2) and read (x+6, 2) are merged into a single access (x+3, 5) where reading and writing are carried out at the same time but with respect to the different memory locations;

read(19, 1)

read(y+2, 1)

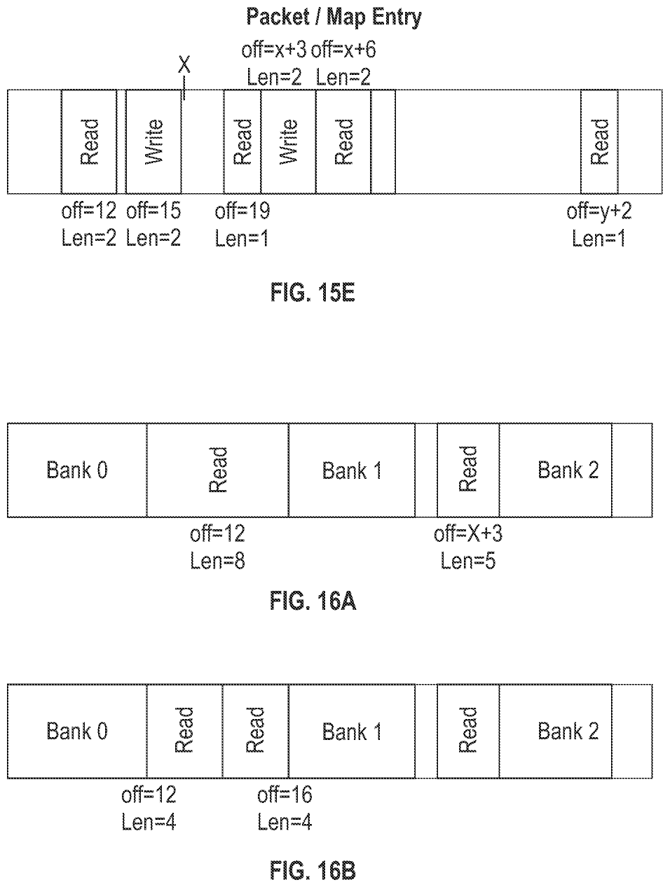

The hardware used to run the compiled program may limit the size and/or alignment of accesses. To address this, the compiler may need to split accesses in certain situations. However, this may be complicated where all the addresses for the accesses are not known. This will now be discussed in relation to FIGS. 16a and 16b.

Referring first to an example where there is a single memory access which spans two memory banks. In this example a bank has a length of 8. The first example access shown in FIG. 16a has an offset of 12 and a length of 8. This means that the access would span two memory banks. As shown, this single access is split into two accesses by the compiler. The first access is to the first memory bank with an offset of 12 and a length of 4 and the second access is to the second memory bank and has an offset of 16 and a length of 4.

However, if the accesses are defined by an offset which needs to be computed, then the addresses of the accesses are not known. Consider the second example shown in FIG. 16a. The offset for the memory access is x+3 and the length is 5. If the access spans two memory banks, then the access should be split. If the access is to one memory bank, then the access does not need to be split.

In some embodiments, the compiler may track properties about the offset x. For example it might be that x is always multiple of 8 and/or might always be in a given range, for example 32<=X<=43. The compiler is configured to make a determination as to whether or not the access will always be to one memory bank or if the access could be two memory locations. Where the compiler determines that, given the properties of x, the access can only be to one memory bank, then the access is not split.

If the compiler determines that the access could be to two or more memory banks, then the compiler or the hardware that runs the compiler will split an access into two or more accesses.

The number of access needed may be determined as follows:

Number of accesses needed N:

N=ceil function((length of access+bank_size−1)/bank_size)

The ceil function returns the smallest integer that is larger or equal to the value of the argument. I.e., ceil(3)=3 ceil(7.5)=8 ceil(8.1)=9 etc.

In the example shown for the read access (x+3, len 5) and a bank size of 16:

N=ceil((5+16−1)/16)=ceil(1.25)

This means that 2 accesses are needed.

The compiler will create the two new accesses.

The compiler creates the computation and the new accesses which are required.

The compiler creates the following computation which is used to determine the first bank in which the offsets occur for the two or more accesses. In the following example, it is assumed that the bank size is 16 with locations 0 to 15.

off_rnd=floor(off/bank_size)*bank_size

A floor function is used which give the greatest integer less than or equal to the offset over the bank size. If the offset is less than the bank size, this means that the first access of the series of accesses is in the first bank, bank 0. If the offset is in the next bank, this would give a value of 16, meaning that the first access of the series of accesses is in the first bank, bank 1.

This is then used when defining the start address of each of the new accesses required.

off1=off_rnd—This is the start address of the first bank, The address of the resulting first access uses the original off value with an adjusted length (to the end of the bank, as discussed below).off2=off_rnd+bank_size
off3=off_rnd+2*bank_size . . .

The hardware will do these same calculations at run time

In general, if the accesses are split and there are three or more access, the middle accesses are different from the first and last accesses.

The middle accesses are always reading a full bank (bank_size), but the start access only reads from the original offset to the end of the bank.

For the start access, the length is therefore:

start_in_bank=(off−off1) (this is the start in the current bank)

the length is therefore len=bank_size−start_in_bank=bank_size−(off−off1)

Similarly, the last split access is cut short, by computing the last byte read (off+len) and how much that “hangs over” in the last bank: (off+len)−off_last.

This may be simplified to allow reading of the entire first and last bank as a separate option.

When the bank size is a power of two, all these computations may be provided by simple bit masking operations.

In summary, in some embodiments:
(1) the access is split;
(2) it is ensured that the first and the last of the split accesses resemble the start/end “coordinates” of the original access;
(3) the accesses in the middle (if any) are full bank accesses.

Thus, the compacity planning by compiler will assume N lines are needed

len1=bank_size−(off−off1)
len2=bank_size . . .
len_last=off+len−off_last

Consider the example shown in FIG. 16a where the offset off is x+3 and the length is 5

This will provide a first access defined by:
off 1=(x+3) & 0xffff . . . f0 (this is the start of the bank for the first access)
offset=x+3 (if access to the full bank is not performed, this will still be the start of the access)
len=16−((x+3) & 0xf)
This will provide a second access defined by:
off=(x+19) & 0xffff . . . f0
len=(x+8) & 0xf

Of course, these assume that the second access is indeed needed. Some logic may be provided to determine if the second access is required.

If the access is indeed needed, for example with x=12, then the: First access:

off1=x+3 & 0xfff . . . f0=15 & 0xff0=0 (this is the start of that bank)
offset=x+3=15 (if access to the full bank is not performed, this will still be the start of the access)
len=16 −((12+3) & 0xf)=16−15=1
Second access:
offset=(12+19) & 0xfff0=31 & 0xff0=16
len=(12+8) & 0xf=20 & 0xf=4

Put another way, the first access will be in the first bank defined by the offset and will access all of the locations between the offset and the end of that bank. Where there are two access, the second access will be in the next (second) bank. The second access will begin at the beginning of the next bank and will be for the next A locations where A is determined by length of access—number of locations accessed in previous bank.

If there are three accesses, then the second access will be to all of the second bank. The third access will be at the beginning of the third bank which follows the second bank. The third access will begin at the beginning of the next bank and will be for the next B locations where A is determined by length of access—number of locations accessed in previous banks.

The is can be extended to where there are four or more accesses.

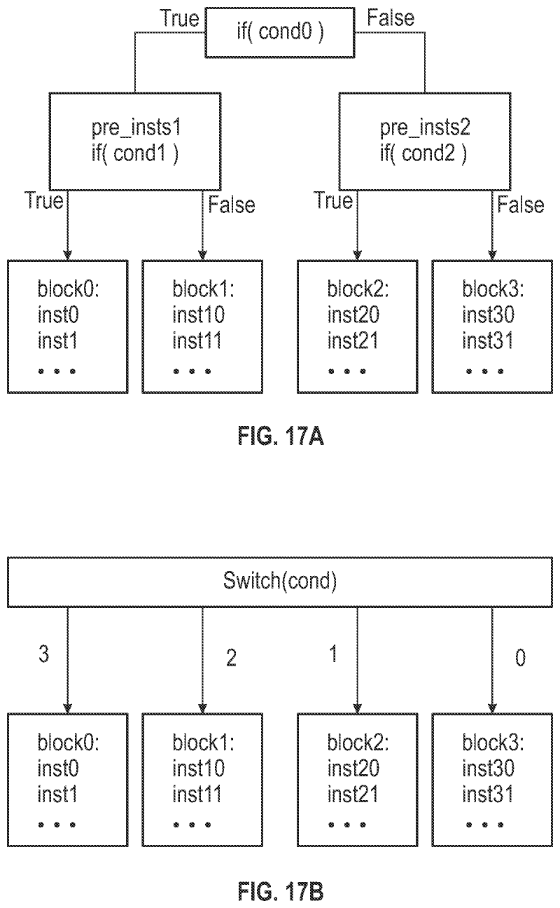

Reference is made to FIGS. 17a and 17b. The hardware may limit the total number of branches which can be supported by a program. The compiler may be configured to reduce the number of branches. This may be challenging where an application has a relatively large number of branches.

A simple example program will be used to illustrate some embodiments.

```
        if( cond0 ) {
  pre_insts1;
  if( cond1 ) {
    /* block0 */
    inst0; inst1; ...
  } else {
    /* block1 */
    inst10; inst11; ...
  }
} else {
  pre_insts2;
  if( cond2 ) {
    /* block2 */
    inst20; inst21; ...
  } else {
    /* block3 */
    inst30; inst31; ...
}
```

This is represented diagrammatically in FIG. 16a. If condition 0 is true, then the program branches to the pre_inst 1 step. If condition 0 is false, then the program branches to the pre_inst 2 step.

With the pre_inst 1 step, if condition 1 is true, then the program branches to block 0. However, if condition 1 is false, then the program branches to block 1.

With the pre_inst 2 step, if condition 2 is true, then the program branches to block 2. However, if condition 2 is false, then the program branches to block 3.

The example program has two branch slots being used:
1. Condition 0
   2. Condition 1/condition 2

If pre_insts1 and pre_insts2 are small (or empty), the compiler can move the instructions up and execute them conditionally:

```
conditional(cond0, pre_insts1)
conditional(!cond0, pre_insts2)
if( cond0 ) {
  if( cond1 ) {...} else {...}
} else {
  if( cond2 ) {...} else {...}
}
```

In this example, the branches are combined into one branch. For that the pre_insts1 and pre_insts2 first need to be moved out of the way and executed conditionally. That in itself does not remove cond1 branch or cond2 branch.

In one modification the two-way branches may be replaced with a single 4-way branch or switch. In the example, executing the pre_insts1 and pre_insts2 conditionally may be a precondition to the switch conversion explained below.

Switch conversion (i.e., merging multiple cascading branches together) is an alternative to full conditional execution (of the instructions in block0, block1, block2, and block3). This is shown in FIG. 16b.

conditional(cond0, pre_insts1)

conditional(!cond0, pre_insts2)

cond=cond0*2+(cond0 ? cond1:cond2)

switch(cond)

case 3:/*block0*/; break;

case 2:/*block1*/; break;

case 1:/*block2*/; break;

case 0:/*block3*/; break;

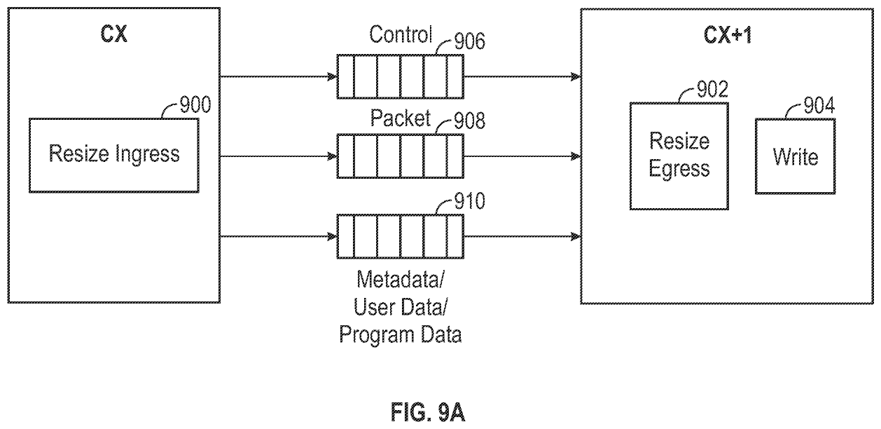

The insertion of data and removal of data from a packet is normally the result of adding of headers and removal of headers which occurs frequently on the NIC in the protocol processing. This will be discussed in relation to FIGS. 9a to c. The problem which needs to be addressed, using the architecture of FIG. 3, is that the data which needs to be added/removed results in a redistribution of data between words. This is managed by the resize tap.

EBPF supports adding/removing space to a packet header. The compiler of some embodiments may cause the packet to be modified without reducing throughput. Packet modification commands may be inserted into the stream by the compiler. The commands may be add N bytes or remove N bytes. The compiler provides packet position tracking logic to update the counting. The compiler provides a packet update unit which will repackage words.

In the cases where bytes are being inserted into the packet, it might take more clock cycles to write the modified packet out than it took for upstream producer to send the unmodified packet to the tap. This means that the resize tap provided by the compiler needs to “back-pressure” the upstream producer—that is to slow the upstream producer down so that the resize tap has enough time to output all the packet words which are arriving.

The decision to accept more data from the upstream producer or to slow the upstream producer down is done on a cycle-by-cycle basis so that they only get delayed when necessary. The decision needs to be made after the resize tap has worked out how the input packet bytes will be packed into words in the output packet, but it needs to be made before the output packet words are actually produced.

That means the resize tap provided by the compiler needs to be split into three parts. The first part works out how the input packet bytes will get packed into the output words. The second part decides whether to delay the upstream producer. The third part packs the input bytes into the output packet words.

The second part controls the rate of arrival of packet words by deciding whether or not to accept another word on each cycle. It is not accepting packet words directly from the upstream producer; rather the second part is accepting the packet words from the first part of the resize tap. It may take a small amount of time for the first part to notice that it is being delayed, during which it will continue to produce data. The delay is expected to be small, so it may be only a single packet word. That word needs to go somewhere and the second part is not ready to accept it.

To make sure packet words do not get lost, in one embodiment, there is a small buffer between the first part of the tap and the second part. That buffer is structured as a set of FIFOs to carry the program state, packet words, and packing information from the first part of the tap to the second. The first part of the resize tap writes information into the buffer while there is space available and the second part reads from the buffer at the correct rate to output packet words at the maximum rate.

This is shown schematically in FIG. 9a. Computational unit CX receives a resize instruction and will provide the control information to computational unit CX+1 which will perform the required resizing. This will repackage the words as required. Computational unit Cx has a resize ingress block 900 providing the first part which works out how the input packet bytes will get packed into the output words. Cx+1 has a resize egress block 902 providing the second part which decides whether to delay the upstream producer and the third or write part 904 which packs the input bytes into the output packet words. The control buffer 906 provides the small buffer between the first part of the tap and the second part. This may be a FIFO.

As previously discussed there is a packet FIFO 908 for the words and a FIFO 910 for the metadata, user data and/or program data.

Consider the following example, Example 1, shown in FIG. 9b. A packet has first data A and second data B, with some data between the first data A and the second data B which is to be deleted. The end of the packet has padding Pad.

Word 1 has data A and part of the data to be deleted. Word 2 has part of the data to be deleted and part of data B. In particular data B is made up of data B1, B2, B3 and B4. Data B1 and B1 are in word 2. Word 3 has data B3 and B4 as well as the padding pad.

The output packet after the deletion of part of the data may be as follows. Word 1 has data A and data B1. Word 2 has data B2 and data B3. Word 3 had data B4 and is padded to fill up the word. Additional padding bits are added to take into account the deleted data.

In some embodiments, the number of words may be reduced to take into the amount of deleted data. In this example, reference is made to Example 2. In this example, the amount of data to be deleted plus the padding is greater than or equal to the size of a word. In this example, words 1, 2 and 3 are similar to that of example 1 except the amount of data to be deleted is greater and data B2 is smaller than in example 1. The output packet after the deletion of part of the data may be as follows. Word 1 has data A and data B1. Word 2 has data B2, data B3 and data B4. The padding may be removed. There is no word 3 required in this example.

A similar operation may be performed when adding data into a packet, potentially increasing the number of words in a packet. In some embodiments, with the insertion of data, 0s are first inserted into the packet and then the 0s will later be replaced with the required data. Reference is made to FIG. 9c. A packet has first data A and second data B, with some data to be inserted between the first data A and the second data B. The end of the packet has padding.

Word 1 had data A and part of the B data B1. Word 2 had part of the B data, data B2 and B3. Word 3 has data B4 and data B5 as well as the padding.

The output packet after the insertion of the 0s may be as follows. Word 1 has data A and some of the 0s. Word 2 has the rest of the 0s, data B1 and some of data B2. Word 3 has rest of data B2, data B3 and data B4. Word 4 is added in and has data B5 and is padded to fill up that word.

The this can be done while streaming and repacking the packet words without reducing throughput

Using two stages and generating additional control words in a separate channel may increase the performance and simplifies the flow, especially in cases where the second stage needs to insert bytes and send multiple output words per input packet word.

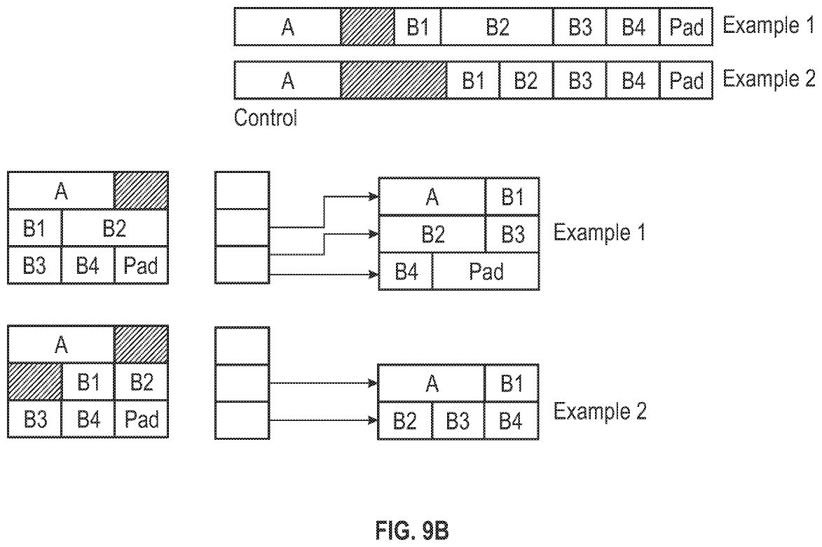

Reference will now be made to FIG. 10 which schematically illustrates the inlining of taps provided by the compiler of some embodiments. A generic tap source code C++ is provided which is a description of the possible taps on the NIC. This may be provided by the PL. This tap source code is compiled to an LLVM-IR. This description is used to provide a link tap output for the EBPF program which is being compiled by the compiler. A tap can be regarded as a piece of code of how to access packets and maps in a generic way. After the generic taps have been linked, they are specialized by the compiler to the provided application code. This is a way of optimizing, by the compiler, the computational hardware (that is, for example, the computational units of the previously described examples).

FIG. 10 shows the compiling stages provided by the compiler 302. The input is the LLVM-IR representation of the EBPF program (referenced 310 in FIG. 3). The LLVM-IR is converged by the compiler in the converge stage 1000 as discussed for example in relation to FIGS. 7 and 8.

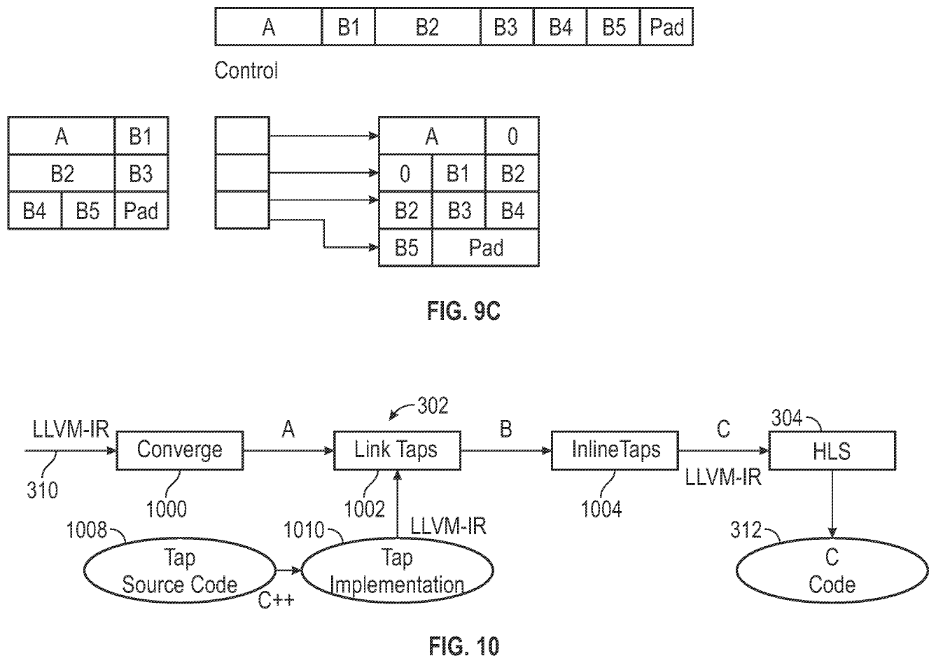

FIG. 11 schematically represents the output of the converge stage 1000 of the compiler and is a representation of a computational unit Cx without any tap information. The computational unit Cx has a packet FIFO and a FIFO of the metadata, user data and/or program data as previously discussed.

Referring back to FIG. 10, the taps are added by the compiler in the link tap stage 1002 to the output of converge stage 1000 using a representation of the tap implementation 1010 of the generic tap source code 1008. The representation of the tap implementation may be an LLVM IR. This tap implementation 1010 will allow an arbitrary number of bytes to be fetched from a set of locations. This means that the generic tap implementation 1010 will have a counting loop which counts the number of bytes which have been processed. The loop will have, for example, stages of: process byte; update count; does count equal number of bytes to be processed; if not process next byte; and repeat loop. This is repeated until the required number of bytes is processed.

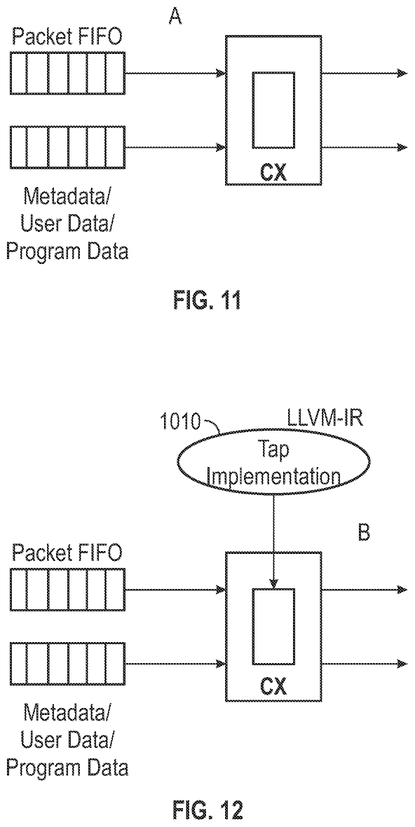

Reference is made to FIG. 12 which schematically shows the computation unit Cx of FIG. 12 to which the generic tap implementation 1010, which is based on the generic tap source code 1008, has been applied.

Referring back to FIG. 10, the inline tap stage 1004 of the compiler represents an optimization process provided by the compiler which optimizes the link taps from the link tap stage 1002 to an inline representation. The optimization takes the information about the number of bytes that are required and replaces the loop with a simple set of instructions of process byte 1, followed by process byte 2 etc.

After the taps have been inlined by the inline tap stage, a LLVM constant propagation pass technique is used to replace the variable number of bytes in the buffer with the number in this particular instance. The LLVM loop unrolling pass is then used to unroll the loop so that the body of the loop is repeated once for each byte of the buffer. The LLVM control-flow-graph simplification pass and the LLVM instruction combiner pass are used to remove instructions which are not required.

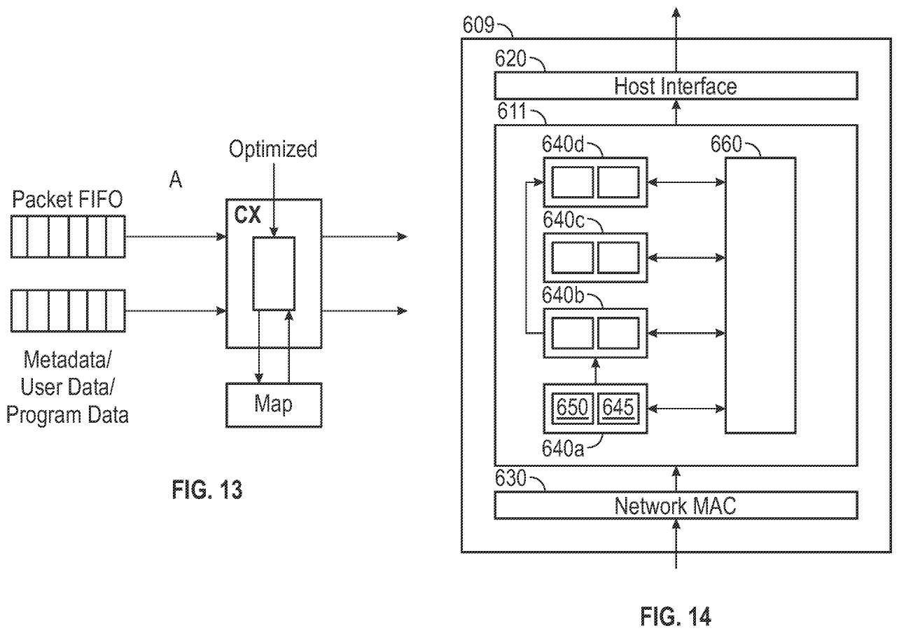

Thus, the instructions to be performed by the computation unit Cx are optimized by the compiler. In the case of a packet access tap, the whole tap gets inlined into the computation unit, so the whole tap gets optimized. The map tap is split into a part for sending a message to the map and a part for receiving a message from the tap. The part for sending the message gets inlined into the computation unit before the access and the part for receiving the message gets inlined into the computation unit after the access. This is schematically represented by FIG. 13.

Consider the following example. Suppose a program reads a non-contiguous series of bytes from a header, for example bytes 0, 9, 16, 17, 18 and 19. The header is located at an unknown offset into the packet. The parameters to the packet read tap allow it to read a contiguous series of bytes from an arbitrary offset in the packet. It is desirable to include only one tap to read all the bytes, so before the optimization step gets performed, the program will include instructions to read all the bytes between offset 0 and offset 19 of the header. This will include instructions to compute the values of bytes which will not be used by the application (bytes 1-8 and 10-15). The optimization step will remove these redundant instructions, leaving only the instructions which are required to compute the values of the bytes which will be used.

This optimization may be used in the case where the location in a packet is fixed. In that case, the constant propagation pass will propagate the constant offset to all the places where it is used and simplify the instructions which access the packet data.

This optimization may further specialise the packet access taps to be able to only access particular offsets within a packet word. For example, it is known that the IP header in the packet is located at offset 14, 18 or 22. If there were 16 bytes in a packet word then that would correspond with offsets 14, 2 or 6 in the packet word because the offsets 16 onwards of the packet turn up as offset 0 onwards of the second packet word. Without this knowledge, the packet tap would need to generate instructions which could select each outgoing byte from 16 possible locations in the incoming packet word. With this knowledge, it only needs instructions to select from three possible locations.

As discussed previously, some embodiments may be used where accesses have been combined into a wider access, but where that may “overread” values that the application ultimately does not need. When the tap is in-lined into the application code and then optimised as discussed, the compiler will determine that some of the bytes that were read by the tap are not needed by the application. The compiler can then optimise them away.

Some embodiments provide generic HW taps for packet and map access in C++.

In some embodiments, the compiler compiles to LLVM-IR and then cross-optimises with the application which is also present in LLVM-IR

In some embodiment, standard compiler optimisations such as inlining are performed, but also specific analysis which interprets the user application and performs advanced constant folding/forwarding in the application (from the setup function describing the maps to the map accesses in the pipeline stages performing the computation).

The program consists of two main pieces:
a packet kernel, which is split into multiple functions, one for each pipeline stage
a setup function which sets up the system and defines properties such as the maps and the connections between the pipeline stages (this may be regarded as a configuration file, but it is written in executable code)

In some embodiments, the setup function is parsed (or symbolically executed) and the configuration parameters are extracted in the compiler. The compiler takes those configuration which are constants and place them into the code that needs them.

Normally, it would be difficult for a conventional compiler to perform this detection, because the communication happens through complicated memory instructions:

```
Setup_function (is executed at start of day)
compiler_setup(...) {
  context.maps[1].configuration = constant,
}
Packet kernel stage 7 (is executed for each packet word):
Stage7ctx, ... ) {
  ...
  map_op(ctx, map1, ...)
  ...
}
map_op(ctx, map_id, ... ) {
  int c = ctxmaps[map_id].configuration /* read the configuration */
}
```

For a conventional compiler to do the constant propagation, it would need to know that the context in compiler_setup is the same as in the packet_kernel (or at least contains the same data), and that there is no manipulation of the context, and that the map_ids match in the correct way. This is not generally straightforward.

In contrast, the compiler of some embodiments may use knowledge of how the system is arranged to propagate the constant from the compiler_setup function into the inlined tap in stage7 in the example above.

Together, that allows an increase in programmer productivity (a single high-level description of the tap functionality makes it easy to change these for different hardware structures; the application programmer can just use accesses and maps of their preferred size without having to worry about performing any inlining or having to use APIs) and still get the benefit of hand-tuned taps (unnecessary loops and branches removed) for any user application.

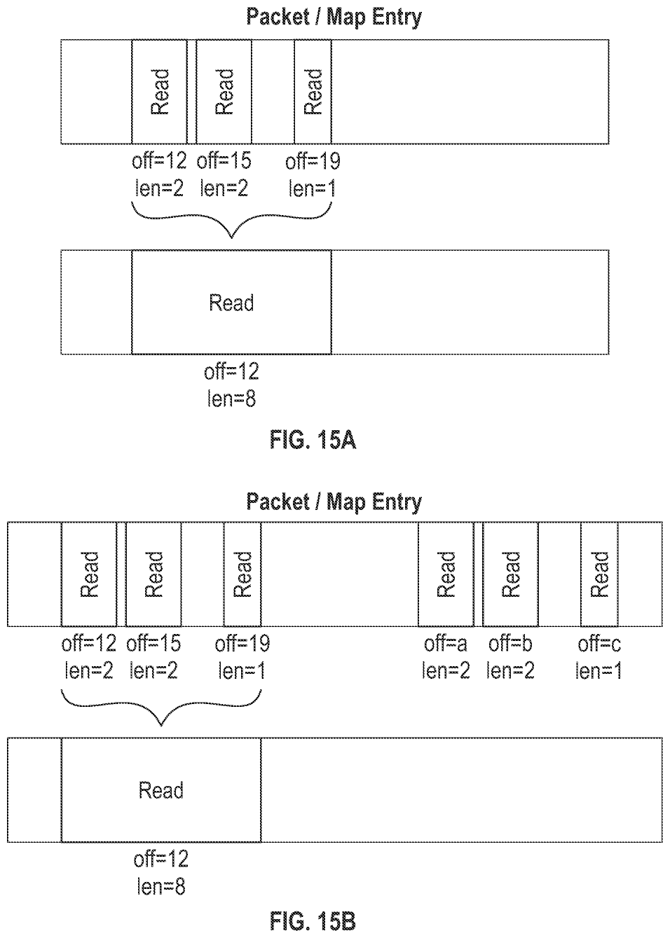

Reference is made to FIG. 14, which illustrates another example of a network interface device 609 of some embodiments. The network interface device comprises a hardware module 611 configured to perform the processing of data packets received at an interface of the network interface device 609. Although, FIG. 14 illustrates the hardware module 611 performing a function (e.g. filtering) for data packets on the receive path, the hardware module 611 may also be used for performing a function (e.g. load balancing or a firewall) for data packets on the transmit path that are received from the host.

The network interface device 609 comprises a host interface 620 for sending and receiving data packets with the host and a network MAC interface 630 for sending and receiving data packets with the network.

The network interface device 609 comprises a hardware module 611 comprising a plurality of processing units 640a, 640b, 640c, 640d. Each of the processing units may be an atom processing unit. The term atom is used to refer to processing units. Each of the processing units may be configured to perform at least one operation in hardware. Each of the processing units may comprise a digital circuit 645 configured to perform the at least one operation. The digital circuit 645 may be an application specific integrated circuit. Each of the processing units may additionally comprises a memory 650 storing state information. The digital circuit 645 may update the state information when executing the respective plurality of operations. In addition to the local memory, each of the processing units has access to a shared memory 660, which may also store state information accessible to each of the plurality of processing units.

The state information in the shared memory 660 and/or the state information in the memory 650 of the processing units may include at least one of: metadata which is passed between processing units, temporary variables, the contents of the data packets, the contents of one or more shared maps.

Together, the plurality of processing units are capable of providing a function to be performed with respect to data packets received at the network interface device 609. The compiler, as discussed previously, outputs instructions to configure the hardware module 611 to perform a function with respect to incoming data packets by arranging at least some of the plurality of processing units to perform their respective at least one predefined operation with respect to each incoming data packet. This may be achieved by chaining (i.e. connecting) together the at least some of the processing units 640a, 640b, 640c, 640d so that each of the connected processing units will perform their respective at least one operation with respect to each incoming data packet. Each of the processing units performs their respective at least one operation in a particular order so as to perform the function. The order may be such that two or more of the processing units execute in parallel with each other, i.e. at the same time. For example, one processing unit may read from a data packet during a time period (defined by a periodic signal (e.g. clock signal) of the hardware module 611) in which a second processing unit also reads from a different location in the same data packet.

In some embodiments, the data packet passes through each stage represented by the processing units in a sequence. In this case, each processing unit completes its processing before passing the data packet to the next processing unit for performing its processing.

In the example shown in FIG. 14, processing units 640a, 640b, and 640d are connected together at compile time, such that each of them performs their respective at least one operation so as to perform a function, e.g. filtering, with respect to the received data packet. The processing units 640a, 640b, 640d form a pipeline for processing the data packet. The data packet may move along this pipeline in stages, each having an equal time period. The time period may be defined according to a period signal or beat. The time period may be defined by a clock signal. Several periods of the clock may define one time period for each stage of the pipeline. The data packet moves along one stage in the pipeline at the end of each occurrence of the repeating time period. The time period may be a fixed interval. Alternatively, each time period for a stage in the pipeline may take a variable amount of time. A signal indicating the next stage in the pipeline may be generated when the previous processing stage has finished an operation, which may take a variable amount of time. A stall may be introduced at any stage in the pipeline by delaying the signal for some pre-determined amount of time

Each of the processing units 640a, 640b, 640d may be configured to access shared memory 660 as part of their respective at least one operation. Each of the processing units 640a, 640b, 640d may be configured to pass metadata between one another as part of their respective at least one operation. Each of the processing units 640a, 640b, 640d may be configured to access the data packet received from the network as part of their respective at least one operation.

In this example, the processing unit 640c is not used to perform processing of received data packets so as to provide the function, but is omitted from the pipeline.

A data packet received at the network MAC layer 630 may be passed to the hardware module 611 for processing. Although not shown in FIG. 14, the processing performed by the hardware module 611 may be part of a larger processing pipeline providing additional functions with respect to the data packet other than the function provided by the hardware module 611.

The first processing unit 640a is configured to perform a first at least one operation with respect to the data packet. This first at least one operation may comprise at least one of: reading from the data packet, reading and writing to shared state in memory 660, and/or performing a look up into a table to determine an action. The first processing unit 640a is then configured to produce results from its at least one operation. The results may be in the form of metadata. The results may comprise a modification to the data packet. The results may comprise a modification to shared state in memory 660. The second processing unit 640b is configured to perform its at least one operation with respect to the first data packet in dependence upon the results from the operation carried out by the first processing unit 640a. The second processing unit 640b produce results from its at least one operation and passes the results to a third processing unit 640d that is configured to perform its at least one operation with respect to the first data packet. Together the first, second, and third processing units 640a, 640b, and 640d are configured to provide a function with respect to a data packet. The data packet may then be passed to the host interface 620, from where it is passed to the host system.

Therefore, it may be seen that the connected processing units form a pipeline for processing a data packet received at the network interface device. This pipeline may provide the processing of an eBPF program which is compiled by the compiler described previously. The LLVM IR 310 provides atom configuration.

The pipeline may provide the processing of a plurality of eBPF programs. The pipeline may provide the processing of a plurality of modules which execute in a sequence.

The connecting together of processing units in the hardware module 611 may be performed by programming a routing function of a pre-synthesised interconnection fabric of the hardware module 611. This interconnection fabric provides connections between the various processing units of the hardware module 611. The interconnection fabric is programmed according to the topology supported by the fabric.

The hardware module 611 supports at least one bus interface. The at least one bus interface receives data packets at the hardware module 611 (e.g. from the host or network). The at least one bus interface outputs data packets from the hardware module 611 (e.g. to the host or network). The at least one bus interface receives control messages at the hardware module 611. The control messages may be for configuring the hardware module 611.

An application may be complied for execution in such a hardware module 611 by mapping a generic program (or multiple programs) to a pre-synthesised data path. The compiler builds the data-path by linking an arbitrary number of processing stage instances, where each instance is built from one of the pre-synthesised processing stage atoms.

Each of the atoms is built from a circuit. Each circuit may be defined using an RTL (register transfer language) or high level language. Each circuit is synthesised using a compiler such as discussed previously. The atoms may be synthesised into hard-logic and so be available as a hard (ASIC) resource in a hardware module of the network interface device. The atoms may be synthesised into soft-logic. The atoms in soft-logic may be provided with constraints which allocate and maintain the place and route information of the synthesised logic on the physical device. An atom may be designed with configurable parameters that specifies an atom's behaviour. Each parameter may be a variable, or even a sequence of operations (a micro-program), which may specify at least one operation to be performed by a processing unit during a clock cycle of the processing pipeline. The logic implementing the atoms may be synchronously or asynchronously clocked.

The processing pipeline of atoms itself may be configured to operate according to a periodic signal. In this case, each the data packet and metadata moves one stage along the pipeline in response to each occurrence of the signal. The processing pipeline may operate in an asynchronous manner. In this case, back pressure at higher levels in the pipeline will cause each downstream stage to start processing only when data from an upstream stage has been presented to it.

When compiling a function to be executed by a plurality of such atoms, a sequence of computer code instructions is separated into a plurality of operations, each of which is mapped to a single atom. Each operation may represent a single line of disassembled instruction in the computer code instruction. Each operation is assigned to one of the atoms to be carried out by one of the atoms. There may be one atom per expression in the computer code instructions. Each atom is associated with a type of operation, and is selected to carry out at least one operation in the computer code instructions based on its associated type of operation. For example, an atom may be preconfigured to perform a load operation from a data packet. Therefore, such an atom is assigned to carry out an instruction representing a load operation from a data packet in the computer code.

One atom may be selected per line in the computer code instructions. Therefore, when implementing a function in a hardware module containing such atoms, there may be 100s of such atoms, each performing their respective operations so as to perform the function with respect to that data packet.

Each atom may be constructed according to one of a set of processing stage templates that determine its associated type of operation/s. The compilation process is configured to generate instructions to control each atom to perform a specific at least one operation based on its associated type. For example, if an atom is preconfigured to perform packet access operations, the compilation process may assign to that atom, an operation to load certain information (e.g. the packet's source ID) from the header of the packet. The compilation process is configured to send instructions to the hardware module, in which the atoms are configured to perform the operations assigned to them by the compilation process.

The processing stage templates that specify an atom's behaviour are logic stage templates (e.g. providing operations over registers, scratch pad memory, and stack, as well as branches) packet access state templates (e.g. providing packet data loads and/or packet data stores), and map access stage templates (e.g. map lookup algorithms, map table sizes).

The compilers and compiling methods of some embodiments have been described in relation to applications in network interface devices or NICs. It should be appreciated, that this is by way of example only and other embodiments may be provided in any other suitable application requiring a compiler.

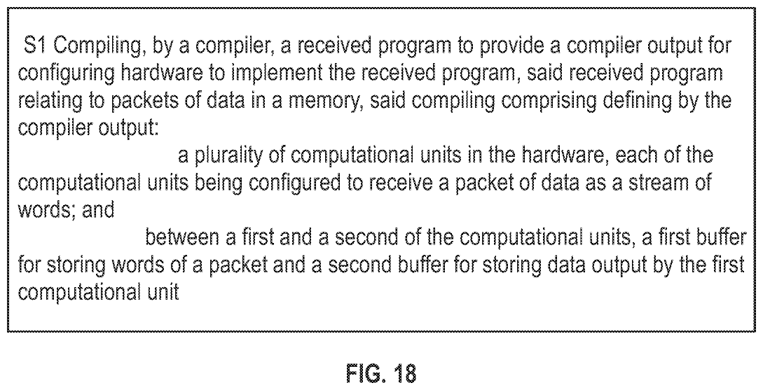

Reference is made to FIG. 18 which shows a method of some embodiments.

This method may be performed by an apparatus. The apparatus may be in or be a network interface device, a host device or any other suitable device.

The apparatus may comprise suitable circuitry for providing the method.

Alternatively or additionally, the apparatus may comprise at least one processor and at least one memory storing instructions that, when executed by the at least one processor cause the apparatus at least to provide the method below.

The method may be provided by computer program code or computer executable instructions.

The method may comprise as referenced S1, compiling, by a compiler, a received program to provide a compiler output for configuring hardware to implement the received program, said received program relating to packets of data in a memory. The compiling may comprise defining by the compiler output a plurality of computational units in the hardware, each of the computational units being configured to receive a packet of data as a stream of words.

The compiling may comprise defining by the compiler output between a first and a second of the computational units, a first buffer for storing words of a packet and a second buffer for storing data output by the first computational unit.

It should be appreciated that the method outlined in FIG. 18 may be modified to include any of the previously described features.

The embodiments may be implemented by computer software stored in a memory and executable by at least one data processor of the involved entities or by hardware, or by a combination of software and hardware.

The software may be stored on such physical media as memory, or memory blocks implemented within the processor or any other suitable data carrier ..

The memory may be of any type suitable to the local technical environment and may be implemented using any suitable data storage technology, such as semiconductor based memory devices, magnetic memory devices and systems, optical memory devices and systems, fixed memory and removable memory.

The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples.

The description of the inventive arrangements provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the inventive arrangements disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

1. A method comprising:
compiling, by a compiler, a received program to provide a compiler output for configuring hardware to implement the received program, said received program relating to packets of data in a memory, said compiling comprising defining by the compiler output:
a plurality of computational units in the hardware, each of the computational units being configured to receive a packet of data as a stream of words; and
between a first and a second of the computational units, a first buffer for storing words of a packet and a second buffer for storing data output by a first computational unit of the plurality of computational units.

2. The method as claimed in claim 1, wherein the data output from the first computational unit comprises data resulting from one or more actions performed by the first computational unit.

3. The method as claimed in claim 1, wherein the data output from the first computational unit comprises one or more of meta data, user data, and/or program data.

4. The method as claimed in claim 1, wherein the compiling comprises determining a plurality of accesses in the received program and converging two or more common accesses to provide a single converged access for two or more instructions, wherein the received program when run will execute one but not other of the two or more instructions.

5. The method as claimed in claim 4, wherein the compiling comprising defining a respective computational unit in the hardware to perform the respective single access.

6. The method as claimed in claim 4, wherein the compiling further comprises determining an order of the plurality of accesses and when converging two or more common accesses, maintaining the order of the plurality of accesses.

7. The method as claimed in claim 4, wherein the compiling further comprises inserting a first converge instruction before the single converged access and/or a second converge instruction after the single converged access.

8. The method as claimed in claim 4, wherein the plurality of accesses comprise map accesses.

9. The method as claimed in claim 4, wherein the plurality of accesses comprise packet accesses.

10. The method as claimed in claim 1, wherein the compiling further comprises adding packet modifying commands in a data stream, said packet modifying commands comprises at least one of adding data to or removing data from a packet.

11. The method as claimed in claim 10, wherein the compiling further comprises providing tracking logic in one or more of the plurality of computational units to track the adding or removing of data from a packet.

12. The method as claimed in claim 1, wherein the compiling further comprises determining that two or more accesses to different memory locations are to be combined in a single access operation when the two or more accesses are within a given range to a same set of memory locations.

13. The method as claimed in claim 1, wherein the compiling further comprises determining that two or more accesses to different memory locations are to be combined in a single access operation when the two or accesses associated with a common computed variable address are within a given range.

14. The method as claimed in claim 1, wherein the compiling further comprises determining that a single memory access is to two or more different sets of memory locations and splitting the single memory access into a plurality of different memory accesses each to a respective set of memory locations.

15. The method as claimed in claim 1, wherein the compiling further comprises determining a number of program branches in the received program and reducing the number of program branches following one another by combining two or more program branches into a switch.

16. The method as claimed in claim 1, wherein the compiling comprises compiling the received program to an intermediate representation and compiling the intermediate representation to provide the compiler output.

17. The method as claimed in claim 1, wherein the received program is an EBPF program.

18. The method as claimed in claim 1, wherein the hardware comprises programmable logic.

19. An apparatus comprising:
a compiler, the compiler being configured to compile a received program to provide a compiler output for configuring hardware to implement the received program, said received program relating to packets of data in a memory, the compiling comprising defining in the compiler output:
a plurality of computational units in the hardware, each of the computational units being configured to receive a packet of data as a stream of words; and
between a first and a second of the computational units, a first buffer for storing words of a packet and a second buffer for storing data output by a first computational unit of the plurality of computational units.

20. A non-transitory computer readable medium having instructions stored thereon which when executed by a processor cause the processor to:
provide a compiler configured to compile a received program to provide a compiler output for configuring hardware to implement the received program, said received program relating to packets of data in a memory, the compiling comprising defining in the compiler output:
a plurality of computational units in the hardware, each of the computational units being configured to receive a packet of data as a stream of words; and
between a first and a second of the computational units, a first buffer for storing words of a packet and a second buffer for storing data output by a first computational unit of the plurality of computational units.
